(19) United States
(12) Patent Application Publication
(10) Pub. No.: US 2025/0238984 A1
(43) Pub. Date: Jul. 24, 2025

(54) Interactive Forums for Specific Regions of a Digital Image

(71) Applicant: eBay Inc., San Jose, CA (US)

(72) Inventors: Richard Chandraguptharajah, Fremont, CA (US); Srikanth Rentachintala, San Jose, CA (US); Niaz Ahamed Khaja Nazimudeen, San Ramon, CA (US); Sandhya J. Fernandes, San Jose, CA (US)

(73) Assignee: eBay Inc., San Jose, CA (US)

(21) Appl. No.: 18/419,241

(22) Filed: Jan. 22, 2024

(51) Int. Cl. G06T 11/60

(52) U.S. Cl. CPC G06T 11/60; G06T 2210/12

(57) ABSTRACT

Interactive forums for specific regions of interest in a digital image are described. An example computing device receives data associated with a digital image of an item from a server. The data indicates a tagged region of the digital image and a plurality of comments associated with the tagged region. The plurality of comments is submitted by a plurality of users at a plurality of client devices. The computing device displays the digital image of the item. The computing device detects input selecting the tagged region of the digital image. The computing device displays, in response to detecting the input selecting the tagged region, a user interface that includes an aggregated view of the plurality of comments and overlays at least part of the user interface on at least part of the digital image outside the tagged region.

### BACKGROUND

Various application and website systems publish digital images to a community of end-users. For example, item listing platforms (e.g., online marketplaces, shopping websites), social networking platforms, and/or other publishing platforms typically publish digital images of items (e.g., products, art, etc.) to their users for inspection or other purposes. In some scenarios, a user may have questions about an item in a digital image. For instance, a user of an item listing platform may need to inquire about an appearance of an item or a surface of the item (e.g., apparent scratches, blemishes, defects, etc.) or some other aspect of an item depicted in a digital image to an owner or administrator of the item listing.

While some conventional systems are configured to provide an email address or other contact information for a user to submit a message describing the inquiry privately to an owner or administrator of an item listing, such approach is limited to generally describing an apparent issue in the inquiring user's own words without a clear way to point out a specific aspect of the item or region of interest in the digital image. Consequently, conventional approaches are prone to human error and typically involve a tedious process of back-and-forth communication between the user submitting the inquiry and the administrator or owner of the digital image or item listing. Furthermore, the owner or administrator may need to respond to a same or similar question from multiple users separately and repeatedly, which is also a tedious or cumbersome process prone to human error.

### SUMMARY

Within examples, an image tagging system is described that displays, at a computing device, a digital image and a user interface that includes an aggregated view of user comments associated with a specific tagged region in the digital image. To do so, the image tagging system receives data associated with the digital image from a server. The data indicates one or more tagged regions and one or more comments submitted by one or more users for each tagged region. The image tagging system then displays, for each tagged region, a user interface that includes an aggregated view of user comments associated with that specific tagged region. The user interface is at least partially overlaid on at least part of the digital image.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. In some implementations, entities represented in the figures are indicative of one or more entities and thus reference is made interchangeably to single or plural forms of the entities in the discussion.

FIG. 1 is an illustration of an environment in an example implementation that is operable to employ an image tagging system to indicate one or more tagged regions of a digital image in a user interface displayed at a computing device and to generate one or more tag user interfaces for displaying comments associated with each tagged region.

FIG. 2 depicts a system in an example implementation showing operation of the image tagging system of FIG. 1 in greater detail.

FIG. 3 depicts examples of a user interface that displays a digital image for which the image tagging system of FIG. 1 is configured to overlay one more tag user interfaces near or adjacent to respective tagged regions in the digital image.

FIG. 4 is a flow diagram depicting a procedure in an example implementation in which a computing device displays a user interface that includes an aggregated view of a plurality of comments associated with a tagged region in a digital image.

FIG. 5 is a flow diagram depicting a procedure in an example implementation in which a server device causes a computing device to display a digital image and a user interface for displaying comments associated with each tagged region in the digital image.

FIG. 6 illustrates an example system including various components of an example device to implement the techniques described with reference to FIGS. 1-5.

### DETAILED DESCRIPTION

### Overview

Various online platforms and computing applications provide user interfaces for a community of users to share digital images for various reasons. For example, online listing platforms (e.g., online marketplaces, shopping websites, etc.) enable a listing user (e.g., seller) to post digital images of an item that other users access. If a digital image of an item has an apparent issue or other region of interest (e.g., scuff on a bracelet of a watch, fold on a corner of a collectible card, etc.), conventional systems typically allow viewing users to contact the listing user (e.g., by email, or contact form) to inquire about the listed item. However, conventional approaches typically do not provide a clear way to point to a specific region of interest in the image. As a result, the process of requesting feedback may result in a tedious and cumbersome experience of back-and-forth communication between the listing user and each viewing user trying to clearly describe their inquiry. Furthermore, in some scenarios, multiple different viewing users send separate inquiries about a same or similar issue which results in additional burdens on the service provider and potentially inconsistent responses.

To address these issues, techniques for tagging digital images and providing a convenient discussion forum for users that is associated to a specific region of interest in a digital image are described. An example image tagging system is described that communicates data associated with a digital image of an item among a plurality of computing devices (e.g., client devices, servers, etc.). The data indicates tagged regions in the digital image and a plurality of comments associated with each tagged region. A tagged region, for example, is a region of the image that is selected by a user. For instance, the tagged region can be indicated to one or more users viewing the image by a border (e.g., defined by a user) that extends around the tagged region. In another example, a tag (e.g., a graphical icon or other graphical user interface (UI) element overlaid on the image to indicate the tagged region).

The plurality of comments is submitted by a plurality of users (e.g., at their client devices). In an example, a listing user (e.g., seller) uploads digital images of an item that has one or more specific regions of interest. The image tagging system displays a digital image in a user interface that enables the listing user to tag specific regions of that digital image. For instance, the image tagging system enables the listing user to add one or more tags to the uploaded digital image to specify or visually indicate one or more specific aspects of the item (e.g., scratches, special components, etc.). In an example, the tag is a graphical icon (e.g., a selectable graphical UI element such as a button, etc.), which may be overlaid at or near a location of the tagged region or in some other location. In another example, the tag is a different graphical UI element that indicates the location of the tagged region (e.g., a border element overlaid on the image and extending around the tagged region). In examples, the image tagging system also provides a tag-specific user interface for each tagged region, which the listing user and/or viewing users can use to comment on the tagged region and/or interact (e.g., like, etc.) with comments submitted by other users about the tagged region. In an example, the tag-specific user interface is configured to be displayed in response to a user selecting a corresponding tag (e.g., by clicking on the tag or tapping it).

In some implementations, the image tagging system is also configured to enable a user to request a computer-generated authenticity check to verify the authenticity of the item in the digital image. For example, a user can use the main user interface or the tag-specific user interface to select a region (e.g., component on backside of a watch) and input a request to predict the authenticity of the item or the selected component. In this example, the image tagging system prepares a request for an authentication server (e.g., a machine learning remote server), which includes information about a selected region of the image, the entire digital image, or the item in the digital image (e.g., model, make, other item attributes in the listing, etc.). The authentication server then generates a prediction of whether the item in the digital image (or the component in the selected region) is authentic. To do so, for example, the authentication server executes a machine learning model that is trained using one or more images of similar items (e.g., neural network) and returns a prediction (e.g., the item is likely authentic, bot is unable to determine authenticity due to insufficient data, etc.).

Furthermore, in at least some implementations, the image tagging system is configured to combine the plurality of comments associated with each tagged region, the authenticity prediction, and/or one or more User Interface (UI) elements (e.g., input elements, graphic elements, etc.) in a uniform or aggregated format (e.g., comment thread, etc.) that clearly conveys information about the associated tagged region to other users. In at least some implementations, the image tagging system is also configured to filter the tags visible to each user depending on permissions assigned by an administrator (e.g., listing user, etc.) of the digital image. For example, regions tagged by the administrator or by the user of a specific client device are selected for display at the specific client device. In some examples, tags authorized by the administrator for display at the client device are also selected. For instance, tags that the administrator deems less useful to share with the public can be excluded from being shared until the administrator authorizes them.

The described systems therefore provide an improved user experience and system capabilities for viewing and discussing specific regions of interest in a digital image among a community of users while also enabling users to visually indicate the regions of interest. Advantageously, the disclosed systems also enable computer-automated services such as authenticity checking and so on that were not previously available or practical to implement. Furthermore, improved user interfaces described in the present disclosure provide a variety of features and system capabilities that are not available in conventional systems.

In the following discussion, an example environment is described that is configured to employ the techniques described herein. Example procedures are also described that are configured for performance in the example environment as well as other environments. Consequently, performance of the example procedures is not limited to the example environment and the example environment is not limited to performance of the example procedures.

### Example Environment

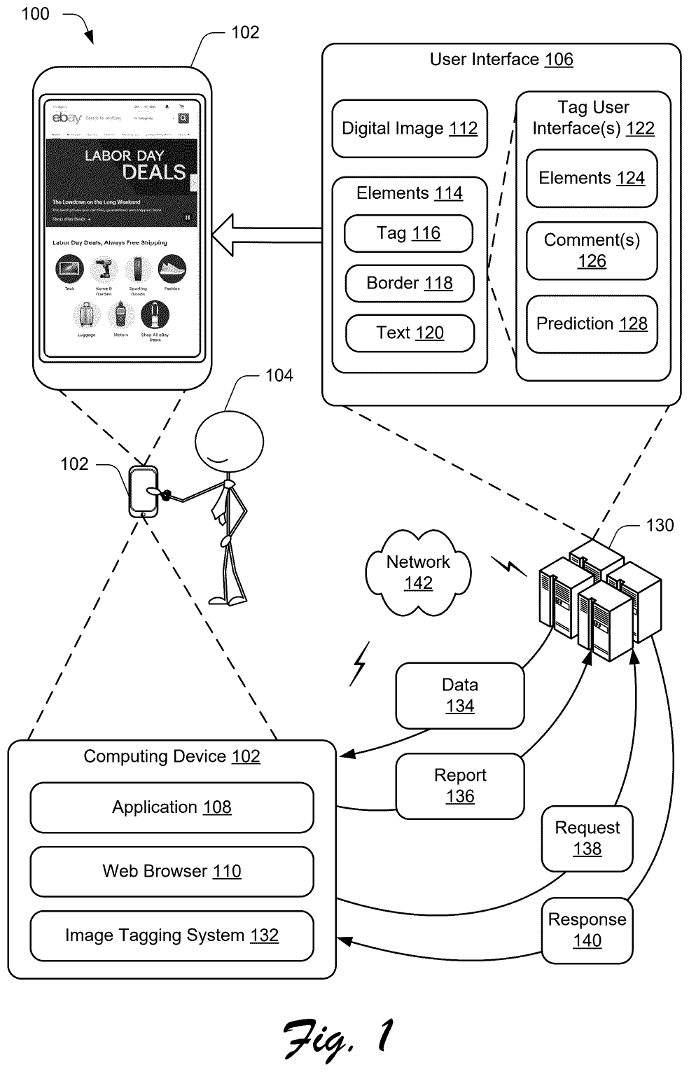

FIG. 1 is an illustration of a digital medium environment 100 in an example implementation that is operable to employ techniques described herein. As used herein, the term “digital medium environment” refers to the various computing devices and resources utilized to implement the techniques described herein. The digital medium environment 100 includes a computing device 102, which is configurable in a variety of manners.

The computing device 102, for instance, is configurable as a desktop computer, a laptop computer, a mobile device (e.g., a handheld or wearable configuration such as a tablet, mobile phone, smartwatch, etc.) as illustrated as being held by a user 104 in the illustrated example of FIG. 1, and so forth. Thus, the computing device 102 ranges from full resource devices with substantial memory and processor resources (e.g., personal computers, game consoles) to low-resource devices with limited memory and/or processing resources (e.g., mobile devices). Additionally, although a single computing device 102 is shown, the computing device 102 is representative of a plurality of different devices, such as a plurality of client computing devices associated with a plurality of users and/or multiple servers utilized to perform operations “over the cloud.”

In the illustrated example, the computing device 102 is configured to display a user interface 106. The user interface 106 is representative of digital content configured to be output for display by an application 108 (e.g., a social networking application, an e-commerce application, a financial application, etc.) and/or a web browser 110 implemented by the computing device 102. The user interface 106, for instance, is representative of a document file written in a markup language, such as Hypertext Markup Language (HTML), configured for consumption by the web browser 110 to be displayed as a web page.

The user interface 106 is configured as including a digital image 112 of an item and a plurality of elements 114, which are representative of aspects that collectively define a visual appearance of, and enable functionality provided by, the user interface 106. For instance, the elements 114 are representative of digital content and/or controls displayed as part of the user interface 106, such as images, videos, text, links, headings, menus, tables, action controls (e.g., radio buttons, edit fields, check boxes, scroll bars, etc.), input elements, and so forth. In accordance with the present disclosure, the elements 114 include graphical elements overlaid (at least partially) on the digital image 112 to visually indicate or otherwise interact with a tagged region of the digital image. For example, the elements 114 as depicted optionally include a tag 116 (e.g., a graphical icon used to visually indicate presence of a tagged region in the digital image 112), a border 118 (e.g., a line, rectangle, or any other shape that extends around the tagged region to indicate its location), and/or text 120 (e.g., a text label or title or any other text user interface element) corresponding to a user-submitted short description of an aspect of the item highlighted by the tagged region among other possibilities. Other possible elements 114 include control elements (e.g., button to enable selecting a region of the image to be tagged, button to enable editing an existing tagged region, button to request an authenticity check for the item in the digital image, etc.) and/or other user interface elements to facilitate various operations and/or functions of the user interface 106.

In the illustrated example, the user interface 106 also includes one or more tag user interfaces 122 corresponding to one or more tagged regions of the digital image 112. For example, each tagged region of the image can be assigned an image-tag-identifier used to associate the tagged region with user comments and/or other data associated with that tagged region. The data associated with the tagged region, for example, can be stored on one or more local or remote storage devices or databases and indexed using the image-tag-identifier. In the illustrated example, each tag user interface 122 optionally includes a plurality of elements 124, one or more user comments 126, and a prediction 128. Similarly to the elements 114, the elements 124 include one or more user interface elements such as control elements, input elements (e.g., like, dislike, comment, reply, request authenticity check, text boxes, etc.), graphical elements (e.g., lines, colors, check marks, etc.), among others.

In this manner, the elements 114 and 124 represent visual components of the user interface 106 and 122 (e.g., images, text, videos, field width elements, alignment elements, etc.) as well as components of the user interface 106 and 122 configured to be interacted with via user input to navigate the user interface 106 and 122 (e.g., chevron elements of a scrollbar), provide text inputs in the user interface 106 and/or 122 (e.g., a text box configured with type-ahead functionality, autofill functionality, etc.), change a display of the user interface 106 and 122 or a tagged region of the digital image (e.g., elements configured to display a drop-down list, elements configured to update one or more data fields displayed in the user interface 106 and 122, elements configured to display an overlay in the user interface 106 and 122, etc.), and so forth.

The tag user interface 122 also includes one or more comments 126, which are comments associated with a specific tagged region of the digital image 112. The comments 126 are submitted by any of a plurality of users (similar to user 104) at any of a plurality of computing devices (similar to computing device 102). For example, each computing device reports user comments associated with a specific tagged region of the digital image 112 to a service provider 130, which then broadcasts them to the computing device 102 for display in the tag user interface 122 associated with that specific tagged region as the comments 126. The prediction 128 is a prediction of whether the item in the digital image 112 is an authentic item. For example, to obtain the prediction 128, a user of the computing device 102 selects an element 124, such as a button in the tag user interface 122 that requests an authentication service provider to check the authenticity of the item in the digital image 112.

In at least some implementations, the tag user interface 122 is configured to display a combination of the comments 126, the prediction 128, and/or the elements 124 in an aggregated format, e.g., as a comment thread that combines information such as identities of users who submitted each comment 126, a time when a comment was submitted, a number of likes or dislikes submitted by users interacting with the comments 126 via the interface, and so on.

It is noted that although the present disclosure describes the various functions of the disclosed systems and methods with respect to a digital image 112, in alternative or additional examples, the various systems and processes described herein are also applicable to other types of digital media. For example, a system of the present disclosure can be used to add tags and/or tag user interfaces (UIs) corresponding to tagged regions in a digital video (e.g., tags and tag UIs associated with regions of a certain video frame or range of video frames in the digital video), and/or a digital audio recording (e.g., tags and tag UIs associated with certain portions or times in an audio stream, etc.), among other types of digital media.

The computing device 102 also includes an image tagging system 132. The image tagging system 132 is implemented at least partially in hardware of the computing device 102. In alternative or additional examples, one or more of the functions described herein for the image tagging system 132 are implemented in the service provider 130. Although illustrated in FIG. 1 as implemented separately from the application 108 and the web browser 110, in some implementations, the image tagging system 132 is representative of functionality integrated into the application 108 and/or the web browser 110.

The image tagging system 132 is configured to receive data 134 from the service provider 130. In general, the service provider 130 is a service provider associated with the user interface 106. To that end, the service provider 130 includes one or more servers, server devices, server systems, configured to communicate with the computing device 102 (and/or other client computing devices) via a network 142. The network 142 includes any wired or wireless network (e.g., the Internet, mobile broadband network, ethernet, etc.) configured to propagate information communicated between the service provider 130 and one or more client computing devices (e.g., computing device 102). The data 134 includes data associated with the digital image 112, such as any combination of data indicating one or more tagged regions in the digital image 112, comments (e.g., comments 126) associated with each tagged region, a unique identifier for each tagged region, users associated with the comments of each tagged region, and so on.

In some examples, the data 134 is received by the computing device 102 based on user input detected in the user interface 106 and/or 122. In an example, the data 134 is received in response to a user selecting the digital image 112 (e.g., via a control element in elements 114, etc.). In another example, the data 134 is received in response to a user adjusting a zoom level while viewing the digital image 112 to a threshold zoom level. For instance, when the threshold zoom level is reached, the computing device 102 and/or the user interface 106 triggers transmitting tag information (e.g., locations of tags or tagged regions within the zoomed portion of the digital image, comments associated with one or more tags within the zoomed portion, etc.). In another example, the service provider 130 transmits the data 134 to the computing device 102 in response to receiving a report from another computing device (not shown) indicating that another user (not shown) has selected a previously untagged region of the digital image 112 as a tagged region. In alternative or additional examples, the data 134 is received by the computing device 102 for a variety of other reasons (e.g., in response to a probe for updates by the computing device 102, passage of a threshold amount of time, etc.).

In response to detecting user input at the elements 114 and/or 124, the image tagging system 132 is configured to generate the report 136 and/or transmit the report 136 to the service provider 130. As an example, if the user 104 selects a region of the digital image 112 to be tagged as a new tagged region, the image tagging system 132 generates the report 136 to indicate information about the new tagged region (e.g., pixel location(s), border shape, text label, etc.) input by the user 104 via the elements 114 so that the service provider 130 can assign an image-tag-identifier for the new tagged region and/or broadcast data about the new tagged region to one or more other computing devices (not shown) of other users who are viewing the digital image 112. In another example, if the user edits a previously existing tagged region, interacts with one or more elements 124 (e.g., adds a new comment, responds to a comment, selects a ‘like’ element, etc.), then the image tagging system 132 generates the report 136 to indicate the relevant tag information (e.g., tag identifier, etc.) and the detected user interaction (e.g., new comment added, etc.) to the service provider 130. In response to receiving the report 136 and/or other reports from other computing devices similar to computing device 102, as noted above, the service provider 130 performs one or more operations such as generating a new unique tag identifier for a new tagged region, transmitting data indicating a detected user interaction at the computing device 102 to other computing devices, and so on.

In at least some implementations, the image tagging system 132 is configured to generate and transmit a request 138 for verifying the authenticity of the item in the digital image 112 to the service provider 130. In an example, the image tagging system 132 detects input via an input element of the elements 114 or 124 requesting an authenticity check for the item in the digital image 112 or a component of the item depicted in a tagged region of the image associated with a tag user interface 122. For instance, if the user 104 selects an action element 124 in the tag user interface 122 for requesting the authenticity check, the image tagging system 132 generates the request 138 to include tag information (e.g., an indication of the tagged region, a tag identifier, a portion of the digital image 112 corresponding to the tagged region, the digital image 112 itself, or any other information about the tagged region or the digital image 112 that the user 104 for which the user 104 wants to verify authenticity). In an example, the request 138 also optionally includes item information associated with the item in the digital image 112 (e.g., name, brand, model, year, or any other item attribute information associated with the item of the digital image 112). For instance, is the user interface 106 is implemented in an item listing platform (e.g., online marketplace, etc.), the image tagging system 132 obtains the item information for the request 138 from a listing of the item that includes the digital image 112.

In response to receiving the request 138, the service provider 130 is configured to use the information in the request 138 to generate a prediction of whether the item of the digital image 112 (or a component of the item depicted in a tagged region of the digital image 112) is authentic. To do so, in at least some implementations, the service provider 130 includes a server configured to execute a machine learning model (e.g., neural network, etc.) trained using one or more images of one or more similar items as the item of the digital image 112. For example, in a listing platform implementation (e.g., online marketplace), the service provider 130 trains a machine learning model using images of similar items listed on the platform or on other platforms labeled as either authentic or unauthentic. The digital image 112 and/or a tagged region therein is then input to the trained machine learning model in an inference mode to generate a prediction of whether the features of the item in the digital image are consistent with features of similar items that are authentic or other similar items that are not authentic. The service provider 130 then transmits an indication of the determined prediction (e.g., prediction 128) as a response 140 to the computing device 102. In response to receiving the response 140, the image tagging system 132 is configured to update the user interface 106 and/or the tag user interface 122 to display the prediction 128 to the user 104. Alternatively or additionally, the service provider 130 updates the user interface 106 remotely (e.g., by populating an element of elements 114 or 124 to display the prediction result).

In general, functionality, features, and concepts described in relation to the examples above and below are employable in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are configured to be applied together and/or combined in different ways. Thus, individual functionality, features, and concepts described in relation to different example environments, devices, components, figures, and procedures herein are useable in any suitable combinations and are not limited to the combinations represented by the enumerated examples in this description.

### Example Systems and User Interfaces

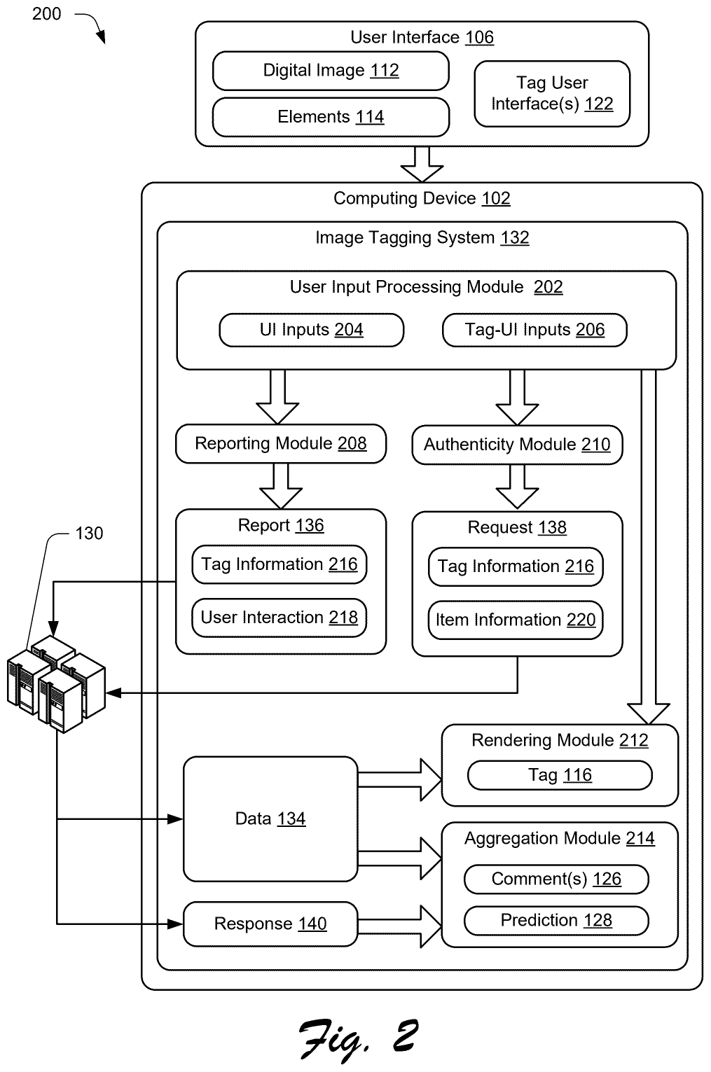

FIG. 2 depicts a system 200 in an example implementation showing operation of the image tagging system 132 in greater detail. In the illustrated example, a user interface 106, including digital image 112, elements 114, and one or more tag user interfaces 122, is received by a computing device implementing the image tagging system 132 and/or output for display by the computing device (e.g., via the application 108 or the web browser 110).

In the illustrated example, the image tagging system 132 includes a user input processing module 202, which is representative of functionality of the image tagging system 132 to detect user inputs received at the user interface 106 (UI inputs 204) and/or at the tag user interface(s) 122 (tag-UI inputs 206). The UI inputs 204 include user inputs corresponding to user interactions with the elements 114. In an example, the UI inputs 204 include a selected region of the digital image 112. For instance, the user 104 indicates the selected region by selecting an input element or action control graphical user interface (GUI) element (e.g., button) that allows the user to select or draw a border around pixels in the image corresponding to the selected region. The user 104, for instance, selects a region of interest in the digital image 112 to request that the selected region be tagged as a new tagged region. Other example the UI inputs 204 received via one or more input elements of the user interface 106 include user inputs for editing an existing tag or tagged region, removing an existing tag or tagged region, adjusting a zoom level of the digital image 112, entering a text or label or title for a tagged region, requesting an authenticity check for the item in the digital image 112, selecting a different digital image to display in the user interface 106 (e.g., instead of the digital image 112), and so on.

In examples, the tag-UI inputs 206 include inputs corresponding to user interactions with one or more of the elements 124 of a specific tag user interface 122. For example, the tag-UI inputs 206 include inputs indicating a new comment or user interaction (e.g., ‘Like’) submitted by the user 104 of the computing device 102 via the specific tag user interface 122 associated with a tagged region. As another example, the tag-UI inputs 206 include inputs indicating a request for an authenticity check for an item in the digital image 112 and/or a component of the item within the tagged region associated with the tag user interface 122 at which the authenticity check input element of elements 124 is included.

The user input processing module 202 is configured to process the UI inputs 204 and Tag-UI inputs 206 so as to provide instructions and/or information needed to operate any of a reporting module 208, authenticity module 210, rendering module 212, and/or an aggregation module 214 of the image tagging system 132. For example, if a user of selects a region of the digital image 112 to be tagged, the user input processing module 202 provides an indication of the selected region and instructions for reporting the new tagged region to the service provider 130. As another example, if the user enters a new comment or interacts with one or more elements 124 of the tag user interface 122, the user input processing module 202 provides information about the tagged region (e.g., tag identifier, tag location, pixel locations, shape of border, etc.) associated with the tag user interface 122. As another example, if the user provides input requesting an authenticity check, the user input processing module provides suitable instructions to the authenticity module 210. As another example, if the user draws a new border of a new tagged region via the user interface 106 or interacts with an input element of the elements 124 of the tag user interface 122, then the user input processing module 202 prepares the relevant instructions and/or information associated with the user interaction to the rendering module 212 so as to update one or more visual components (e.g., tag 116, border 118, text 120, other elements 114 or 124) of the user interface 106, 122 and/or to the aggregation module 214 to aggregate the new comment/user interaction with the other comments. As yet another example, where the user inputs a request for performing an authenticity check, the user input processing module 202 transmits relevant inputs or information needed to operate the authenticity module 210, and so on.

The reporting module 208 is configured generate and/or transmit the report 136 to the service provider 130 based on user inputs detected at the user interface 106 and/or the tag user interfaced 122. For example, the reporting module 208 optionally includes tag information 216 and/or a user interaction 218 in the report 136, depending on the context of the user inputs and/or instructions received from the user input processing module 202. For example, if the report 136 is for indicating a user interaction 218 with an element 124 of the tag user interface 122 associated with an existing tagged region (e.g., new comment, interaction with a ‘like’ GUI element, etc.), then the reporting module 208 includes a tag identifier or other indicator that is sufficient for the service provider 130 to identify the tagged region. As another example, if the report 136 is for reporting a region of the digital image 112 that is selected to be tagged as a new tagged region, then the reporting module 208 may include additional tag information 216 such as a pixel location, pixel range, size, border style, text label, and/or any other information necessary for the service provider 130 to store a new record (and/or create a new tag identifier) for the new tagged region.

The authenticity module 210 is configured to generate and/or transmit the request 138 for verifying an authenticity of the item in the digital image 112 (or a component of the item associated with a specific tagged region). To that end, the authenticity module 210 is configured to provide various types of the tag information 216 in line with the discussion above (e.g., tag identifier, tagged region pixel locations, portion of the digital image 112 corresponding to the tagged region, the digital image 112, etc.). In at least some implementations the authenticity module 210 is further configured to include item information 220 in the request 138. For example, the authenticity module 210 includes item information 220 such as name, price, model, etc., or any other item attribute information available to the computing device 102 (and/or unavailable to the service provider 130).

The rendering module 212 is configured to populate, generate, overlay, modify, and/or otherwise manipulate one or more visual components of the user interface 106 and 122 based on the data 134 received from the service provider 130, the UI inputs 204, and/or the tag-UI inputs 206. By way of example, the rendering module 212 is configured to receive the data 134 from the service provider 130, where the data 134 indicates one or more tagged regions of the digital image 112 and one or more user comments associated with each tagged region. In response to receiving the data 134, the rendering module 212 is configured to display one or more GUI elements 114 (e.g., tag 116, border 118, text 120) to indicate presence of each tagged region. In at least some implementations, the rendering module 212 is configured to overlay (at least partially) the one or more GUI elements 114 on the digital image to visually indicate the location of a tagged region. For example, the rendering module 212 draws a border 118 overlaid on the digital image 112 and extending around the tagged region to visually indicate the location of the tagged region. As another example, the rendering module 212 overlays a text element (e.g., label, title, short description, etc.) associated with the tagged region at a location near or adjacent to the tagged region to further visually indicate the tagged region. In additional or alternative examples, the rendering module 212 is configured to display or hide one or more of the tag user interfaces 122 based on the UI user inputs 204 and/or the tag UI user inputs 206. For example, the rendering module 212 is configured to overlay at least part of a tag user interface 122 on at least part of the digital image 112 at a location adjacent to (or near) an associated tagged region. Further, in an example, the rendering module 212 displays that tag user interface 122 in response to detecting user input of the UI inputs 204 selecting an associated tag 116 and/or the tagged region itself; and/or hides that displayed tag user interface 122 in response to detecting user input of the tag-UI inputs 206 via input element assigned to indicate that the user wishes to hide that particular tag user interface 122.

In at least some implementations, the rendering module 212 is configured to filter a plurality of tagged regions included in the data 134 to select one or more tagged regions to render in the tag user interface 122 of the computing device 102. For example, the rendering module 212 selects tagged regions that were tagged by a user of the computing device 102 or an administrator of the digital image 112 and excludes tagged regions that were tagged by other users (unless such tagged regions were authorized by the administrator for display to the user of the computing device 102). In this example, the system 200 advantageously enables the administrator to prevent unhelpful comment threads (e.g., spam or offensive material) from being published to the entire community of viewing users without the administrator's (e.g., owner of a listed item or uploader of the digital image 112) authorization for publishing tags submitted by third parties.

The aggregation module 214 is configured to aggregate content associated with a tagged region for display in the tag user interface 122 by combining the elements 124, the comments 126, a user identity associated with each of the comments 126, and/or the prediction 128 associated with the tagged region into an aggregated or uniform format (e.g., as a comment thread with interactive elements such as ‘Like’, ‘Reply’, etc., under each comment). For example, the aggregation module 214 is configured to identify one or more comments associated with a specific tagged region from the data 134 received from the service provider 130, and/or to identify a prediction associated with the same tagged region from the response 140 received from the service provider. In this example, the aggregation module 214 is then configured to combine the identified comments 126 and/or prediction 128 into an aggregated format for display in the tag user interface 122 associated with that tagged region. As another example, the aggregation module 214 receives tag-UI inputs 206 indicating a new comment or other user interaction submitted by a user of the computing device 102 via the tag user interface 122. In response to receiving tag-UI inputs 206, the aggregation module 214 is configured to aggregate the new user interaction with the other comments 126 and/or prediction 128 to update the aggregated view of comments in the tag user interface 122.

Although the image tagging system 132 is illustrated as being implemented in the computing device 102, in additional or alternative implementations, one or more of the functions described above for the image tagging system 132 are optionally implemented in other computing devices and/or servers of the service provider 130. For example, the functionality of filtering tagged regions for the user of the computing device 102 and/or other functionalities described above for the rendering module 212 and/or the aggregation module 214 can alternatively be implemented remotely by the service provider 130 and provided to the computing device 102 as part of the data 134 or by directly updating the user interface 106 and/or 122. Other implementations are possible as well.

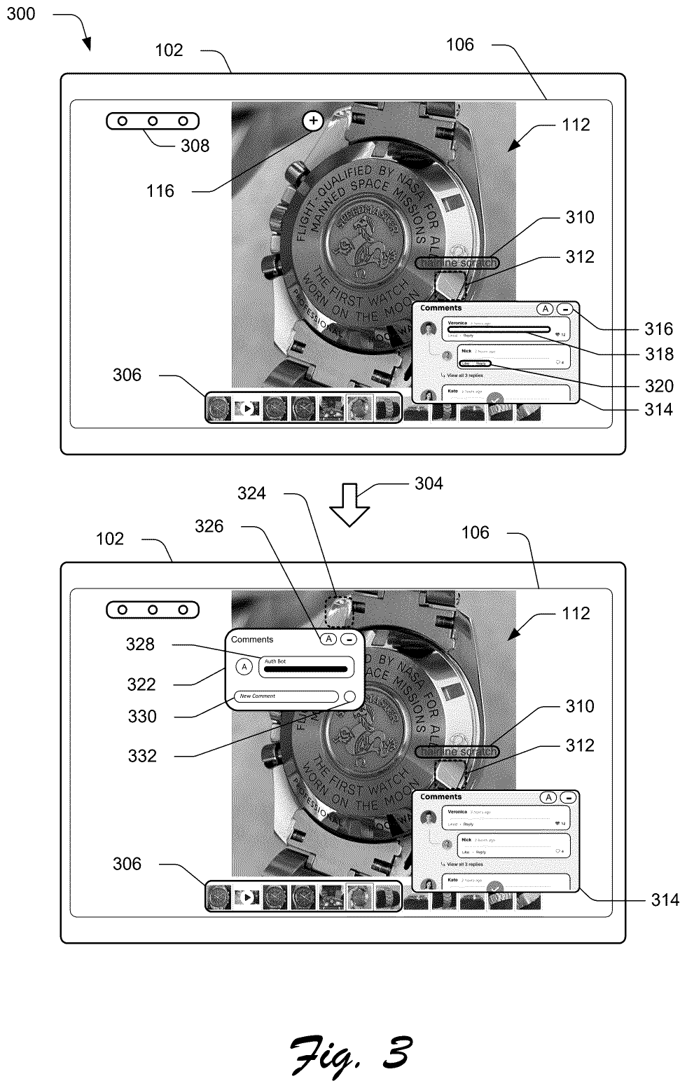

FIG. 3 is an illustration of a digital medium environment 300 in an example implementation of the user interface 106 rendered at the computing device 102 and an example tag user interface 322 displayed in response to detecting input selecting the tag 116 via the user interface 106. For example, FIG. 3 depicts a scenario, as indicated by arrow 304, where the user interface 106 is output for display via a display device (e.g., a screen) associated with the computing device 102, and then modified to display the tag user interface 322 in response selection of the tag 116.

The illustrated example depicts various examples of elements 114 that may be included as part of the user interface 106. For instance, the user interface 106 is depicted as including icon elements 306 (e.g., thumbnail images) that are selectable to display different digital images (such as the currently selected digital image 112 in the illustrated example) in the user interface 106. The user interface 106 also includes graphical control elements 308 that are selectable to enable a user to perform various actions. In an example, a graphical control element 308 is configured as an input element that enables a user to select a region of the digital image 112 (e.g., by activating a drawing tool that allows the user to draw a border extending around the region of interest that the user wants to select). As another example, the graphic control elements 308 include a selectable GUI element that enable the user to edit an existing tag, border, text, or tagged region. As yet another example, the graphic control elements 308 include a selectable GUI element that enables the user to submit a request for verifying the authenticity of the item (e.g., watch) depicted in the digital image 112 based on a region of interest selected by the user in the digital image 112 or based on the digital image 112. In the illustrated example, the user interface 106 also includes a text 310 (similar to text 120) which is a graphical element overlaid on the digital image 112 and positioned at a location adjacent to or near an associated tagged region (the region encompassed by border 312). The user interface 106 also includes the border 312 (similar to border 118) which is overlaid on the digital image 112 (depicted by dashed lines in FIG. 3 for clarity) and extends around the tagged region associated with the border 312.

The user interface 106 is also depicted to include a tag user interface 314 (similar to tag user interface 122) that is associated with the specific tagged region (encompassed by the border 312). The tag user interface 314 is positioned such that at least part of the tag user interface 314 is overlaid on at least part of the digital image 112 (and is positioned near or adjacent to its associated tagged region). The tag user interface 314 in the illustrated example also provides examples of the elements 124 and comment(s) 126 described in connection with FIG. 1. For example, the tag user interface 314 includes a graphical control element 316 configured to receive input from the user indicating a request to hide the tag user interface 314 (and/or other GUI elements of its associated tagged region such as the border 312 and the text 310). The tag user interface 314 also includes an aggregated view of a plurality of comments (e.g., comment 318 submitted by ‘Veronica’ and the comments submitted by ‘Mark’ and ‘Kate’). In particular, the plurality of comments displayed in the tag user interface 314 are associated with the same tagged region and presented in an aggregated format (e.g., comment thread) together with one or more elements 124 (e.g., selectable elements 320 labeled as ‘Like’ or ‘Reply’) grouped with each comment 318, etc. to enable a user to interact with the specific comment. For instance, selecting the ‘like’ selectable element increases a counter of the number of likes received from users viewing this specific comment associated with the tagged region of border 312.

The user interface 106 is also depicted to include the tag 116, which indicates the presence of another tagged region that is partially hidden in the first drawing of the device 102 (at the top of the page in FIG. 3). Although FIG. 3 shows the tag 116 as being overlaid on the digital image at a location near or adjacent to another tagged region, in alternative examples, the tag 116 is alternatively positioned outside the digital image 112 (e.g., near the elements 308, etc.). In yet other alternative examples, the tag 116 is alternatively omitted. For example, the various tagged regions of the digital image 112 can be identified by borders (e.g., border 312) and can be selectable to show or hide their respective tag user interfaces.

In the illustrated example however, for the sake of discussion, the tag 116 is a graphical control element that is selectable to cause the computing device 102 to display another tag user interface associated with another tagged region. For example, as indicated by the arrow 304, in response to a user selecting the tag 116, the computing device 102 updates the user interface to display a border 324 extending around a second tagged region and a second tag user interface 322 that is positioned outside the first tagged region (of the border 312), the second tagged region (encompassed by the border 324) and the part of the digital image 112 on which the other tag user interface 314 is positioned. Further, the second tag user interface 322 is positioned adjacent to or near its associated second tagged region. Inside the second tag user interface 322, an aggregated view of comments and/or predictions associated with the second tagged region is displayed. For example, the second tag user interface 322 includes a graphical control element 326 that is configured to indicate that the user requests an authenticity check based on a portion of the watch depicted in the second tagged region. In response, the computing device 102 receives a prediction and displays it in a similar aggregated or uniform format (e.g., as a comment 328 authored by a computer-generated fictional user called ‘Auth Bot’) inside the second tag user interface 322.

Furthermore, in the illustrated example, the second tag user interface includes additional examples of the elements 124, such as the input element 330 which can be used by the user of the computing device 102 to enter new comments (e.g., text, images, videos, etc.) for inclusion in the aggregated view of comments associated with the specific tagged region encompassed by the border 324. To facilitate submitting the new comment, the second tag user interface 322 also includes a graphical control element 332 (e.g., a ‘submit’ button) to trigger the process of updating the aggregated view of comments in the second tag user interface 322 and reporting the new comment (e.g., via the reporting module 208) to the service provider 130.

### Example Procedures

The following discussion describes techniques that are configured to be implemented utilizing the previously described systems and devices. Aspects of each of the procedures are configured for implementation in hardware, firmware, software, or a combination thereof. The procedures are shown as a set of blocks that specify operations performed by one or more devices and are not necessarily limited to the orders shown for performing the operations by the respective blocks. In portions of the following discussion, reference is made to FIGS. 1-3.

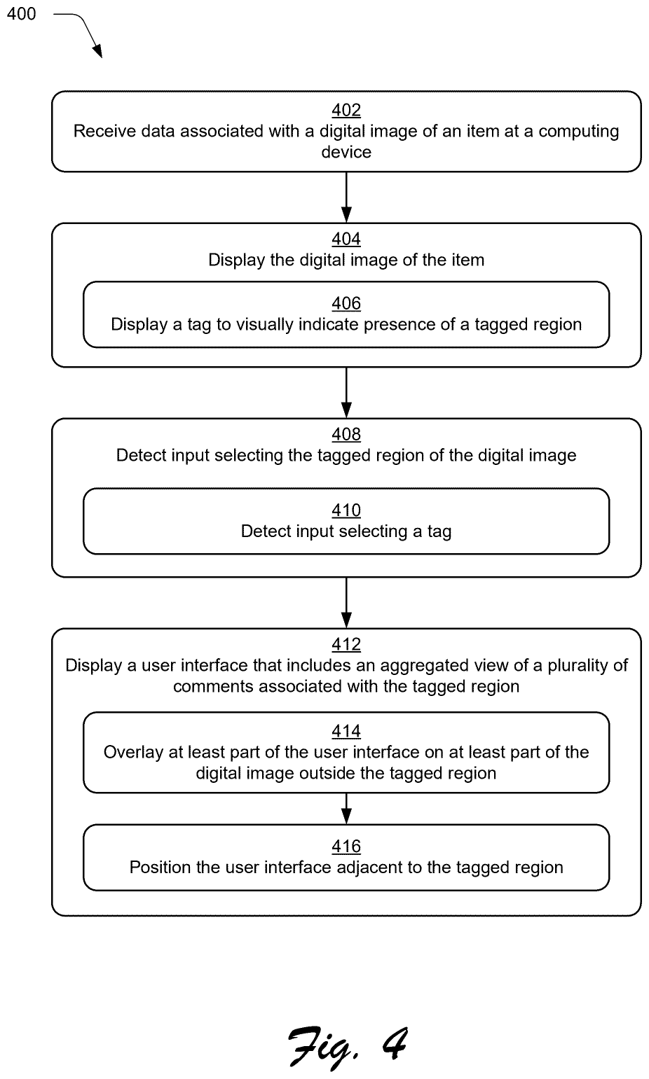

FIG. 4 depicts a procedure 400 in an example implementation of interactive forums for specific regions of a digital image. To begin, a client device or computing device 102 receives data 134 associated with a digital image 112 from a service provider 130 (block 402). For instance, the data 134 indicates a tagged region (e.g., region encompassed by border 312) of the digital image and a plurality of comments 126 (e.g., comment 318, etc.) associated with the tagged region. In examples, the plurality of comments 126 are submitted by a plurality of users at a plurality of client devices (e.g., computing devices similar to computing device 102), similarly to the comments submitted by the users labeled ‘Veronica’, ‘Mark’, and ‘Katie in FIG. 3.

The computing device 102 displays the digital image 112 of the item (block 404). For instance, the digital image 112 of a watch is displayed in the user interface 106 of FIG. 3. In some examples, the procedure 400 also includes the computing device 102 displaying one or more tags (e.g., tag 116) to visually indicate presence of one or more corresponding tagged regions in the digital image 112 (block 406).

The computing device 102 then detects input selecting a tagged region of the digital image 112 (block 408). In an example, the computing device 102 configures portions of the digital image 112 corresponding to the tagged regions encompassed by border 312 or border 324 to be selectable. Alternatively or additionally, the computing device 102 displays a tag 116 to indicate presence of the tagged region (encompassed by border 324) in the digital image 112, and detects input selecting the tag 116 associated with that tagged region (block 410).

In response to detecting the input selecting the tagged region of the digital image 112, the computing device 102 displays a user interface 322 that includes an aggregated view of the plurality of comments and/or predictions (e.g., comment 328) associated with the tagged region (block 412). In at least some implementations, the computing device 102 overlays at least part of the user interface 322 on at least part of the digital image 112 (block 414) outside the tagged region (e.g., encompassed by border 324), as depicted in FIG. 3 for example. Further, in at least some implementations, the computing device 102 positions the user interface 322 near or adjacent to the tagged region (block 416).

In at least some implementations, the computing device 102 overlays text 310 (e.g., label, title, etc.) on the digital image 112 at a location adjacent to or near an associated tagged region. The text associated with that tagged region, for example, is indicated in the data 134 received from the service provider 130.

In at least some implementations, the computing device 102 filters a plurality of tagged regions (e.g., indicated in the data 134 from the server) to select the tagged region of border 312 and/or the tagged region of border 324 for display at the computing device 102. For instance, a tagged region is selected based on the tagged region being tagged by a user of the computing device 102, tagged by an administrator of the digital image 112, or authorized by the administrator for display to the user of the client device.

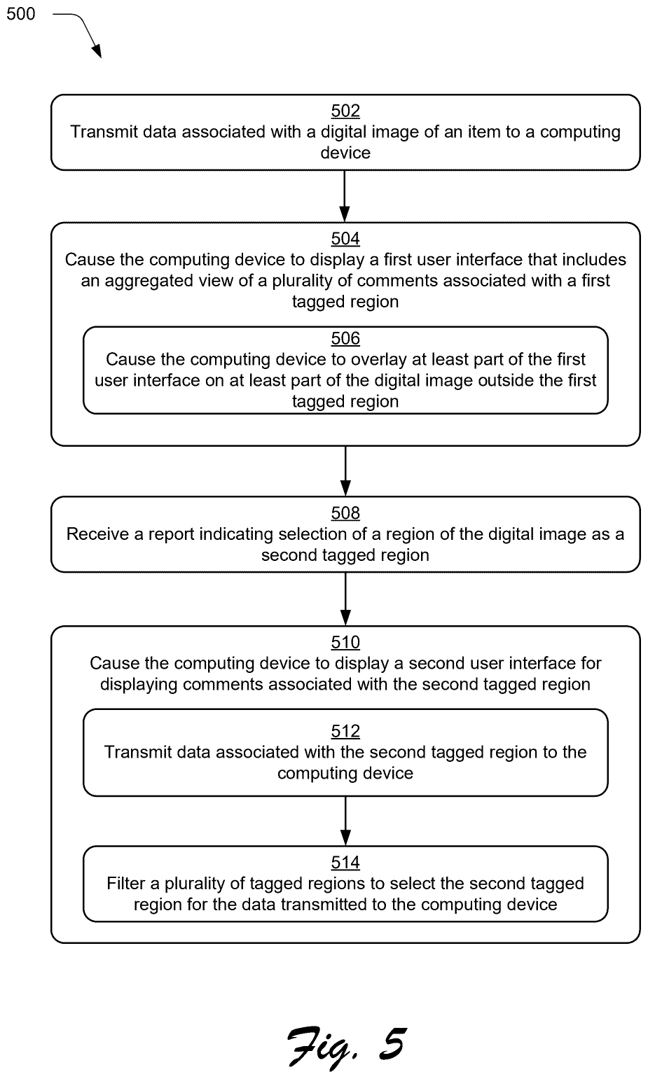

FIG. 5 depicts a procedure 500 in an example implementation of a server device configured to provide interactive forums for specific regions of a digital image. To begin, the service provider 130, for instance, transmits data 134 associated with a digital image 112 to a computing device 102 (block 502). The data 134 indicates a first tagged region (e.g., region encompassed by border 312) of the digital image 112 and a plurality of comments (e.g., comment 318 and other comments submitted by users ‘Veronica’, ‘Mark’, and ‘Katie) submitted by a plurality of users at a plurality of client devices (e.g., computing devices similar to computing device 102) and associated with the first tagged region.

The service provider 130 causes the computing device 102 to display a first user interface that includes an aggregated view of the plurality of comments associated with the first tagged region (block 504). In at least some implementations, the service provider 130 also causes the computing device 102 to overlay at least part of the first user interface 314 on at least part of the digital image 112 outside the first tagged region (block 506).

The service provider 130 receives at least one report from at least one of the plurality of client devices indicating a plurality of tagged regions of the digital image 112, including a report 136 (e.g., from the computing device 102 or from a different client device) indicating selection of a region of the digital image as a second tagged region (e.g., the region encompassed by border 324) (block 508).

In response to receiving the report 136, the service provider 130 causes the client computing device 102 to display a second user interface 322 for displaying comments (e.g., comment 126) associated with the second tagged region (block 510). In at least some implementations, service provider 130 transmits data associated with the second tagged region to the computing device 102 (block 512), for instance, in response to receiving the report 136 (e.g., from a different client computing device). In at least some implementations, the service provider 130 is configured to filter the plurality of tagged regions (e.g., indicated in the at least one report from at least one of the plurality of client computing devices) to select the first tagged region (e.g., encompassed by border 312) and/or the second tagged region (e.g., encompassed by border 324) for inclusion in the data transmitted to the computing device 102 (block 514). For example, the service provider 130 filters the plurality of tagged regions to select a given tagged region based on the given tagged region being: tagged by a user 104 of the computing device 102, tagged by an administrator (e.g., owner of item, uploader of digital image 112, a user having administrator privileges over the digital image 112, etc.) of the digital image 112, or authorized by the administrator for display to the user of the client device.

Having described example procedures in accordance with one or more implementations, consider now an example system and device to implement the various techniques described herein.

### Example System and Device

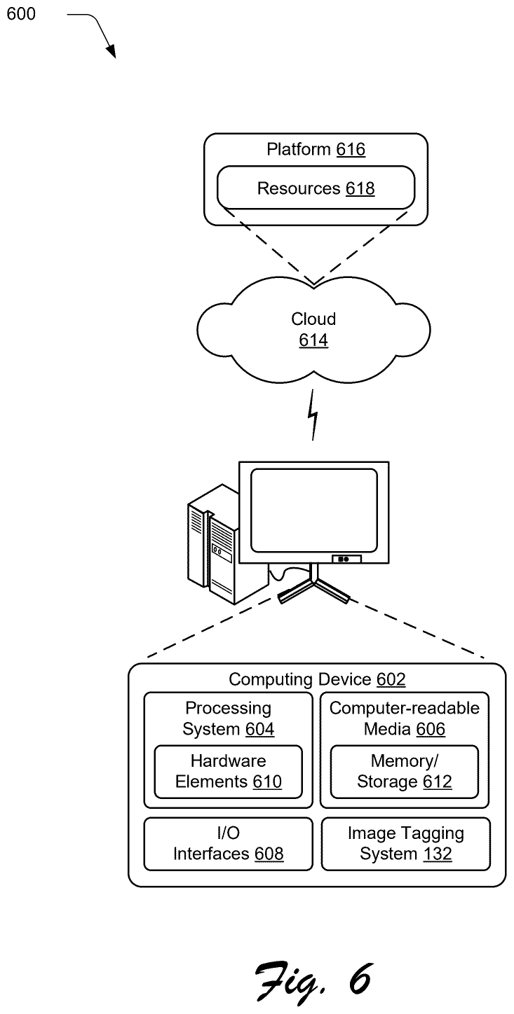

FIG. 6 illustrates an example system 600 that includes an example computing device 602, which is representative of one or more computing systems and/or devices that implement the various techniques described herein. This is illustrated through inclusion of the image tagging system 132 The computing device 602 is configured, for example, as a service provider server, as a device associated with a client (e.g., a client device), as an on-chip system, and/or as any other suitable computing device or computing system.

The example computing device 602 as illustrated includes a processing system 604, one or more computer-readable media 606, and one or more I/O interface 608 that are communicatively coupled, one to another. Although not shown, the computing device 602 is further configured to include a system bus or other data and command transfer system that couples the various components, one to another. A system bus includes any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 604 is representative of functionality to perform one or more operations using hardware. Accordingly, the processing system 604 is illustrated as including hardware element 610 that are configurable as processors, functional blocks, and so forth. For instance, hardware element 610 is implemented in hardware as an application specific integrated circuit or other logic device formed using one or more semiconductors. The hardware elements 610 are not limited by the materials from which they are formed, or the processing mechanisms employed therein. For example, processors are alternatively or additionally comprised of semiconductor(s) and/or transistors (e.g., electronic integrated circuits (ICs)). In such a context, processor-executable instructions are electronically executable instructions.

The computer-readable storage media 606 is illustrated as including memory/storage 612. The memory/storage 612 represents memory/storage capacity associated with one or more computer-readable media. The memory/storage 612 is representative of volatile media (such as random-access memory (RAM)) and/or nonvolatile media (such as read only memory (ROM), Flash memory, optical disks, magnetic disks, and so forth). The memory/storage 612 is configured to include fixed media (e.g., RAM, ROM, a fixed hard drive, and so on) as well as removable media (e.g., Flash memory, a removable hard drive, an optical disc, and so forth). In certain implementations, the computer-readable media 606 is configured in a variety of other ways as further described below.

Input/output interface(s) 608 are representative of functionality to allow a user to enter commands and information to computing device 602 and allow information to be presented to the user and/or other components or devices using various input/output devices. Examples of input devices include a keyboard, a cursor control device (e.g., a mouse), a microphone, a scanner, touch functionality (e.g., capacitive, or other sensors that are configured to detect physical touch), a camera (e.g., a device configured to employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 602 is representative of a variety of hardware configurations as further described below to support user interaction.

Various techniques are described herein in the general context of software, hardware elements, or program modules. Generally, such modules include routines, programs, objects, elements, components, data structures, and so forth that perform particular tasks or implement particular data types. The terms “module,” “functionality,” and “component” as used herein generally represent software, firmware, hardware, or a combination thereof. The features of the techniques described herein are platform-independent, meaning that the techniques are configured for implementation on a variety of commercial computing platforms having a variety of processors.

An implementation of the described modules and techniques are stored on or transmitted across some form of computer-readable media. The computer-readable media include a variety of media that is accessible by the computing device 602. By way of example, and not limitation, computer-readable media includes “computer-readable storage media” and “computer-readable signal media.”

“Computer-readable storage media” refers to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information for access by a computer.

“Computer-readable signal media” refers to a signal-bearing medium that is configured to transmit instructions to the hardware of the computing device 602, such as via a network. Signal media typically embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 610 and computer-readable media 606 are representative of modules, programmable device logic and/or fixed device logic implemented in a hardware form that is employed in some embodiments to implement at least some aspects of the techniques described herein, such as to perform one or more instructions. Hardware, in certain implementations, includes components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware as well as a hardware utilized to store instructions for execution, e.g., the computer-readable storage media described previously.

Combinations of the foregoing are employed to implement various techniques described herein. Accordingly, software, hardware, or executable modules are implemented as one or more instructions and/or logic embodied on some form of computer-readable storage media and/or by one or more hardware elements 610. The computing device 602 is configured to implement instructions and/or functions corresponding to the software and/or hardware modules.

Accordingly, implementation of a module that is executable by the computing device 602 as software is achieved at least partially in hardware, e.g., through use of computer-readable storage media and/or hardware elements 610 of the processing system 604. The instructions and/or functions are executable/operable by one or more articles of manufacture (for example, one or more computing devices 602 and/or processing systems 604) to implement techniques, modules, and examples described herein.

The techniques described herein are supported by various configurations of the computing device 602 and are not limited to the specific examples of the techniques described herein. This functionality is further configured to be implemented all or in part through use of a distributed system, such as over a “cloud” 614 via a platform 616 as described below.

The cloud 614 includes and/or is representative of a platform 616 for resources 618. The platform 616 abstracts underlying functionality of hardware (e.g., servers) and software resources of the cloud 614. The resources 618 include applications and/or data that is utilized while computer processing is executed on servers that are remote from the computing device 602. Resources 618 also include services provided over the Internet and/or through a subscriber network, such as a cellular or Wi-Fi network.

The platform 616 is configured to abstract resources and functions to connect the computing device 602 with other computing devices. The platform 616 is further configured to abstract scaling of resources to provide a corresponding level of scale to encountered demand for the resources 618 that are implemented via the platform 616. Accordingly, in an interconnected device embodiment, implementation of functionality described herein is configured for distribution throughout the system 600. For example, in some configurations the functionality is implemented in part on the computing device 602 as well as via the platform 616 that abstracts the functionality of the cloud 614.

### CONCLUSION

Although the invention has been described in language specific to structural features and/or methodological acts, the invention defined in the appended claims is not necessarily limited to the specific features or acts described. Rather, the specific features and acts are disclosed as example forms of implementing the claimed invention.

What is claimed is:

1. A method comprising:
receiving, by a client device, data associated with a digital image of an item from a server, the data indicating a tagged region of the digital image and a plurality of comments associated with the tagged region, the plurality of comments submitted by a plurality of users;
displaying, by the client device, the digital image of the item;
detecting, by the client device, input selecting the tagged region of the digital image; and
displaying, in response to detecting the input selecting the tagged region, a user interface that includes an aggregated view of the plurality of comments, wherein displaying the user interface includes overlaying at least part of the user interface on at least part of the digital image outside the tagged region.

2. The method of claim 1, wherein displaying the user interface includes positioning the user interface adjacent to the tagged region.

3. The method of claim 1, further comprising displaying, by the client device, a tag to visually indicate that the digital image includes the tagged region.

4. The method of claim 3, wherein detecting the input selecting the tagged region includes detecting input selecting the tag.

5. The method of claim 1, further comprising overlaying, by the client device, a border on the digital image, the border extending around the tagged region.

6. The method of claim 1, further comprising overlaying, by the client device, text associated with the tagged region on the digital image at a location adjacent to the tagged region and outside the at least part of the digital image overlaid by the user interface, wherein the data received from the server includes an indication of the text associated with the tagged region.

7. The method of claim 1, further comprising:
detecting, by the client device, input at an input element of the user interface; and
updating, by the client device, the user interface to indicate a user interaction with the input element by a user of the client device.

8. The method of claim 7, wherein the user interaction includes a comment submitted by a user of the client device, wherein updating the user interface includes aggregating the comment with the plurality of comments to update the aggregated view of the plurality of comments in the user interface.

9. The method of claim 7, further comprising transmitting, by the client device, a report indicating the user interaction to the server.

10. The method of claim 1, further comprising:
transmitting, by the client device, a request to authenticate the item of the digital image to the server; and
receiving, by the client device, a prediction of whether the item in the digital image is authentic from the server in response to transmitting the request.

11. The method of claim 10, further comprising receiving, by the client device, input requesting authentication of the item in the digital image, wherein transmitting the request is in response to receiving the input requesting the authentication of the item.

12. The method of claim 11, wherein receiving the input requesting the authentication includes receiving input selecting a region of the digital image, and wherein transmitting the request includes transmitting at least one of the digital image, an indication of the selected region of the digital image, or an indication of the item.

13. The method of claim 10, wherein the prediction is based on a machine learning model trained using images of one or more items similar to the item of the digital image.

14. The method of claim 10, further comprising updating the user interface to indicate the prediction.

15. The method of claim 1, wherein the tagged region is a first tagged region, wherein the user interface is a first user interface, wherein the at least part of the digital image is a first part of the digital image, the method further comprising:
detecting, by the client device, input selecting a region of the digital image different than the first tagged region;
communicating, by the client device, a report to the server, the report identifying the selected region as a second tagged region of the digital image; and
displaying, by the client device, a second user interface for displaying comments associated with the second tagged region, wherein displaying the second user interface includes overlaying at least part of the second user interface on a second part of the digital image outside the first tagged region, the second tagged region, and the first part of the digital image.

16. The method of claim 1, wherein the data received from the server includes an indication of a plurality of tagged regions of the digital image, the method further comprising:
filtering, by the client device, the plurality of tagged regions to select the tagged region based on the tagged region being tagged by a user of the client device, tagged by an administrator of the digital image, or authorized by the administrator for display to the user of the client device.

17. A method comprising:
transmitting, by a server, data associated with a digital image of an item to a client device, the data indicating a tagged region of the digital image and a plurality of comments associated with the tagged region, the plurality of comments submitted by a plurality of users;
causing, by the server, the client device to display the digital image of the item; and
causing, by the server, the client device to display a user interface that includes an aggregated view of the plurality of comments in response to detection of input selecting the tagged region and to overlay at least part of the user interface on at least part of the digital image outside the tagged region.

18. The method of claim 17, wherein the client device is a first client device, wherein the user interface is a first user interface, wherein the tagged region is a first tagged region, the method further comprising:
receiving, by the server, a report from a second client device, the report indicating selection of a region of the digital image as a second tagged region of the digital image; and
causing, by the server, the first client device to display a second user interface for displaying comments associated with the second tagged region by transmitting data associated with the second tagged region to the first client device in response to receiving the report from the second client device.

19. The method of claim 17, further comprising:
receiving, by the server, at least one report from at least one of a plurality of client devices, the at least one report indicating a plurality of tagged regions in the digital image; and
filtering, by the server, the plurality of tagged regions to select the tagged region for the data transmitted to the client device based on the tagged region being tagged by a user of the client device, tagged by an administrator of the digital image, or authorized by the administrator for display to the user of the client device.

20. A system comprising:
at least one processor; and
a computer-readable storage medium storing instructions that are executable by the at least one processor to perform operations comprising:
communicating data associated with a digital image of an item among a plurality of computing devices, the data indicating a tagged region of the digital image and a plurality of comments associated with the tagged region, the plurality of comments submitted by a plurality of users;
displaying the digital image of the item at a computing device;
detecting input at the computing device selecting the tagged region of the digital image; and
displaying, in response to detecting the input selecting the tagged region, a user interface at the computing device that includes an aggregated view of the plurality of comments, wherein displaying the user interface includes overlaying at least part of the user interface on at least part of the digital image outside the tagged region.
